(19) United States
(12) Patent Application Publication
(10) Pub. No.: US 2011/0275010 A1
(43) Pub. Date: Nov. 10, 2011

(54) CATALYTIC MATERIAL

(76) Inventor: Minhua Shao, Manchester, CT (US)

(21) Appl. No.: 13/101,283

(22) Filed: May 5, 2011

Related U.S. Application Data
(60) Provisional application No. 61/331,431, filed on May 5, 2010.

(51) Int. Cl. H01M 4/92

(52) U.S. Cl. 429/524; 429/523; 429/525

(57) ABSTRACT

A catalytic material includes a plurality of nanoparticles that each comprise a gold substrate and a catalyst on the gold substrate. The gold substrate includes surface facets of which a predominant amount are Au(100)-oriented crystal planes.

### RELATED APPLICATION

This application claims priority to U.S. Provisional No. 61/331,431, filed May 5, 2010.

### FIELD OF THE DISCLOSURE

This disclosure generally relates to catalytic materials for use in fuel cells or other devices.

### BACKGROUND OF THE DISCLOSURE

Fuel cells and other types of devices commonly utilize electroactive materials. For instance, a typical fuel cell may include an anode catalyst, a cathode catalyst, and an electrolyte between the anode and the cathode catalysts for generating an electric current in a known electrochemical reaction between a fuel and an oxidant.

One issue encountered with fuel cells is the operational efficiency of the catalysts. For example, electrochemical activity at the cathode catalyst is one parameter that controls the efficiency. One indication of the electrochemical activity is the rate of electrochemical reduction of the oxidant at the cathode catalyst. Elevated temperatures and potential cycling may cause degradation of the electrochemical activity of the electroactive materials over time due to catalyst dissolution and particle migration.

The catalytic activity and stability for a given electroactive material depends to a considerable degree on such parameters as composition, processing techniques, and physical structure. As an example, some techniques may produce relatively large catalyst particle sizes, which may yield poor electrochemical activity in a fuel cell environment.

### SUMMARY

Disclosed is a catalytic material that includes a plurality of nanoparticles that each comprise a gold substrate and a catalyst on the gold substrate. The gold substrate includes surface facets of which a predominant amount are Au(100)-oriented crystal planes. The catalytic material may be used in a fuel cell.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example fuel cell.

FIG. 2 illustrates an example catalytic material.

FIG. 3 illustrates another example catalytic material.

FIG. 4 illustrates an example nanoparticle having a solid core and shell.

FIG. 5 illustrates another example nanoparticle having a hollow core and shell.

FIG. 6 illustrates another example nanoparticle having a hollow cage.

FIG. 7 illustrates a sectional view of FIG. 6.

FIG. 8 illustrates a graph of surface atom percentage versus particles size for a conventional cubo-octahedral Au sample.

### DETAILED DESCRIPTION

FIG. 1 schematically illustrates selected portions of an example fuel cell 50. In this example, a single fuel cell unit 52 is shown, however, it is to be understood that multiple fuel cell units 52 may be stacked in a known manner in the fuel cell 50 to generate a desired amount of electric power. It is also to be understood that this disclosure is not limited to the arrangement of the example fuel cell 50, and the concepts disclosed herein may be applied to other fuel cell arrangements or to other catalytic devices.

The fuel cell 50 includes an electrode assembly 54 located between an anode interconnect 56 and a cathode interconnect 58. For instance, the anode interconnect 56 delivers fuel, such as hydrogen gas, to the electrode assembly 54. Likewise, the cathode interconnect 58 delivers oxygen gas, such as air, to the electrode assembly 54. In this regard, the anode interconnect 56 and the cathode interconnect 58 are not limited to any particular structure, but may include channels or the like for delivering the reactant gases to the electrode assembly 54.

The electrode assembly 54 includes an anode catalyst 60, a cathode catalyst 62, and an electrolyte 64 located between the anode catalyst 60 and the cathode catalyst 62. The electrolyte 64 may be any suitable type of electrolyte for conducting ions between the anode catalyst 60 and the cathode catalyst 62 in an electrochemical reaction to generate the electric current. In a few examples, the electrolyte 64 may be a polymer electrolyte membrane, a solid oxide electrolyte, or other type of electrolyte, such as phosphoric acid (H₃PO₄).

As is generally known, the hydrogen at the anode catalyst 60 disassociates into protons and electrons. The protons are conducted through the electrolyte 64 to the cathode catalyst 62. The electrons flow through an external circuit 66 to power a load 68, for example. The electrons from the external circuit 66 combine with the protons and oxygen at the cathode catalyst 62 to form a water byproduct. In this example, the anode catalyst 60, the cathode catalyst 62, or both may be comprised of a catalytic material (i.e., electroactive material), as described in the following examples. The catalytic material is stable and highly active under elevated temperatures and corrosive conditions, such as those found within the fuel cell 50.

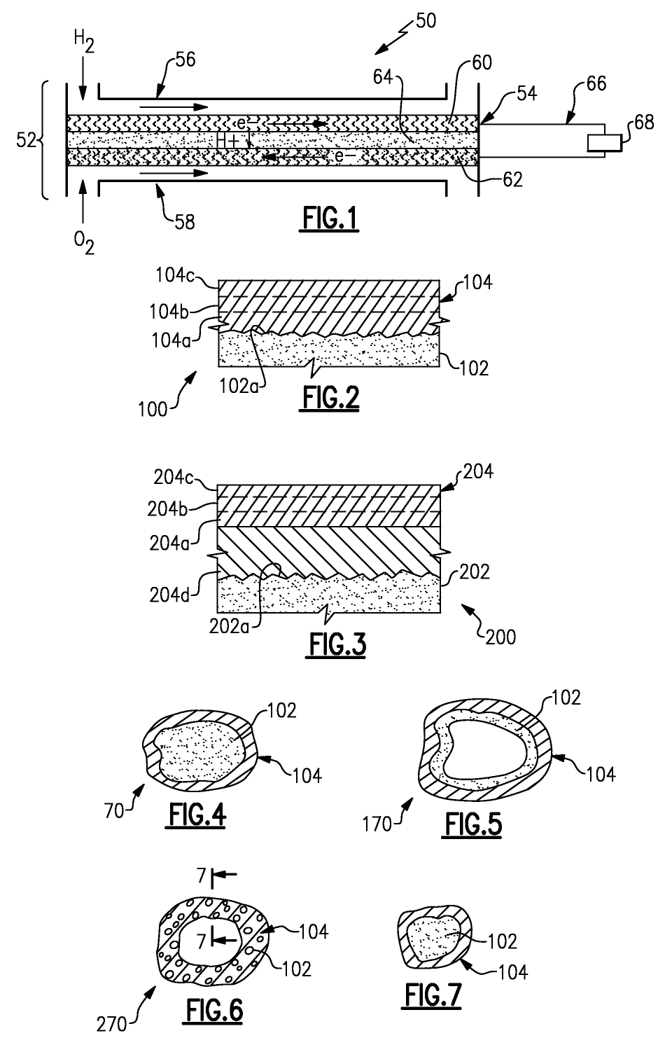

FIG. 2 illustrates a cross-section of selected portions of an example catalytic material 100 that is used in the fuel cell 50 within the anode catalyst 60, cathode catalyst or both. As will be described, the catalytic material 100 is in the form of a nanoparticle. In this example, the catalytic material 100 includes a gold substrate 102 and a catalyst 104 (electroactive material) disposed on the gold substrate 102. In the example, the gold substrate 102 is composed of substantially pure gold, with the exception of trace amounts of impurities.

In the illustrated example, the catalyst 104 is a multilayer structure that includes a first layer 104a, a second layer 104b, and a third layer 104c. The first layer 104a adjoins the second layer 104b and the gold substrate 102. The second layer 104b adjoins the first layer 104a and the third layer 104c. It is to be understood that the layers 104a-c are only examples of the multilayer structure and that the catalyst 104 may include additional layers or fewer layers than illustrated.

Using multiple layers in the catalyst 104 enhances the durability of the catalytic material 100 under the high temperature and potential cycling conditions of a fuel cell environment and enhances the electrochemical activity of the catalytic material 100.

FIG. 3 illustrates another example catalytic material 200 that may alternatively be used in the fuel cell 50 as described above. In this disclosure, like reference numerals designate like elements where appropriate, and reference numerals with the addition of one-hundred or multiples thereof designate modified elements that are understood to incorporate the same features and benefits of the corresponding previously described elements. In this example, the catalytic material 200 is similar to the catalytic material 100 of FIG. 2 except that the catalyst 204 includes a fourth, additional layer 204d that adjoins the first layer 204a and the gold substrate 202.

As an example, the fourth layer 204d comprises a different material than the material of the remaining layers 204a-c, with regard to chemical composition. For instance, the material of the layers 204a-c is platinum and the material of the fourth layer 204d includes palladium and/or iridium. In a further example, the composition of the fourth layer 204d includes palladium, iridium or both, and is free of platinum, and the remaining layers 204a-c include platinum and are free of palladium, iridium or both.

In the illustrated example, the fourth layer 204d between the layers 204a-c and the gold substrate 202 facilitates increasing the durability and electrochemical activity of the catalytic material 200. That is, the palladium or other material selected for the fourth layer 204d facilitates stabilizing the material of the layers 204a-c relative to the gold substrate 202, which may otherwise interact or become mobile relative to one another.

The gold substrates 102 and 202 include respective surface facets 102a and 202a on which the catalyst 104 or 204d is deposited. In the disclosed examples, the surface facets 102a and 202a of the respective gold substrates 102 and 202 include at least a predominant amount of Au(100)-orientated crystal planes relative to other orientations of crystal planes, such as Au(111)-orientated crystal planes. The term “Au(100)-orientated crystal planes” refers to the family of planes that are equivalent.

In some examples, the surface facets 102a and 202a include a majority of Au(100)-orientated crystal planes relative to other orientations of crystal planes. In further examples, substantially all of the surface facets 102a or 202a are Au(100)-orientated crystal planes. As is generally known, (100)-oriented crystal planes correspond to the cubic crystallographic structure. Thus, the gold substrate 102 or 202 has a cubic crystal structure or compound crystal structure that includes the cubic structure, such as cuboctahedron.

In the disclosed examples, the Au(100)-orientated crystal planes facilitate achieving greater electrochemical activity of the catalyst 104 or 204. That is, upon deposition, the catalyst 104 or 204 adopts the (100)-orientation of the Au(100)-orientated crystal planes. The (100)-orientation of the catalyst 104 or 204 exhibits enhanced activity (e.g., Oxygen Reduction Reaction or “ORR”).

The following examples in FIGS. 4-7 are based on the catalytic material 100; however, it is to be understood that the examples can alternatively be based on the catalytic material 200. FIG. 4 illustrates an example nanoparticle 70 that is composed of the catalytic material 100. As an example, the nanoparticle 70 may have an average particle size determined on a nanoscopic scale. In some examples, the nanoscopic scale may be 1-100 nanometers. However, for many end uses, a desirable particle size may be less than about 10 nanometers, or even under 5 nanometers. A plurality of the nanoparticles 70 may be provided in a known arrangement as a catalytic material in the fuel cell 50 as described above. In this case, the nanoparticle 70 includes the gold substrate 102 as a core particle and the catalyst 104 as a shell that generally surrounds the core particle. The core in this example is a dense, solid particle that is coated with the catalyst 104.

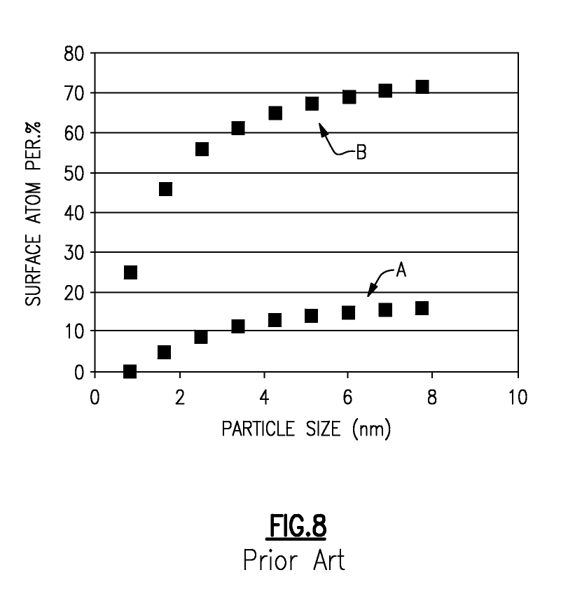

FIG. 5 illustrates another example nanoparticle 170 that is somewhat similar to the nanoparticle 70 described above. In this case, the nanoparticle 170 includes the gold substrate 102 as a hollow particle and the catalyst 104 as a shell that generally surrounds the hollow particle. In the illustrated example, the center portion of the hollow particle is an open space.

FIG. 6 illustrates another example nanoparticle 270 that is somewhat similar to the nanoparticle 170 described above. In this case, the gold substrate 102 is provided as a porous “cage” that surrounds a hollow, open core space. The porous “cage” may be considered to be similar to the shell of FIG. 5, but with an open porosity between the interior open space and the exterior surroundings. The catalyst 104 is a coating that substantially covers the free surfaces of the cage structure, as illustrated for example in the section shown in FIG. 7.

FIG. 8 illustrates a graph of surface atom percentage versus particle size for a conventional cubo-octahedral Au sample. The data points indicated as “A” represent the percentage of surface atoms associated with Au(100)-orientated crystal planes. The data points indicated as “B” represent the percentage of surface atoms with the Au(111)-orientated crystal planes. The percentage of surface atoms associated with Au(100)-orientated crystal planes is lower than the percentage of surface atoms associated with the Au(111)-orientated crystal planes. That is, a conventional cubo-octahedral Au sample normally includes a greater percentage of atoms associated with the Au(111)-orientated crystal planes. The catalytic material of this disclosure has a predominant amount of surface atoms in Au(100)-oriented crystal planes.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A catalytic material comprising:
a plurality of nanoparticles that each comprise a gold substrate and a catalyst on the gold substrate, the gold substrate includes surface facets of which a predominant amount are Au(100)-oriented crystal planes.

2. The catalytic material as recited in claim 1, wherein the catalyst comprises a multilayer structure.

3. The catalytic material as recited in claim 2, wherein the multilayer structure includes a first layer having a first composition and a second layer having a second, different composition.

4. The catalytic material as recited in claim 3, wherein the first composition comprises palladium and is free of platinum, and the second composition comprises platinum and is free of palladium.

5. The catalytic material as recited in claim 3, wherein the first composition comprises iridium and is free of platinum, and the second composition comprises platinum and is free of iridium.

6. The catalytic material as recited in claim 3, wherein the first composition comprises iridium and palladium and is free of platinum, and the second composition comprises platinum and is free of palladium and iridium.

7. The catalytic material as recited in claim 1, wherein the catalyst comprises a multilayer structure that includes a palladium layer that is in contact with the gold substrate.

8. The catalytic material as recited in claim 1, wherein the gold substrate includes a cubic crystal structure.

9. The catalytic material as recited in claim 1, wherein the gold substrate includes a cuboctahedron crystal structure.

10. The catalytic material as recited in claim 1, wherein the gold substrate is a solid core particle and the catalyst is a coating that surrounds the solid core particle.

11. The catalytic material as recited in claim 1, wherein the gold substrate is a hollow core particle and the catalyst is a coating that surrounds the hollow core particle.

12. The catalytic material as recited in claim 1, wherein the gold substrate is a hollow, porous cage and the catalyst is a coating that is disposed on free surfaces of the cage.

13. A fuel cell comprising:
a catalytic material having a plurality of nanoparticles that each comprise a gold substrate and a catalyst on the gold substrate, the gold substrate includes surface facets of which a predominant amount are Au(100)-oriented crystal planes.

14. The fuel cell as recited in claim 13, comprising an electrode assembly that includes the catalytic material within at least one of an anode catalyst or a cathode catalyst, with an electrolyte located between the anode catalyst and the cathode catalyst.

15. The fuel cell as recited in claim 14, wherein the electrode assembly is located between an anode interconnect and a cathode interconnect.
